(19) United States
(12) Patent Application Publication
(10) Pub. No.: US 2014/0305680 A1
(43) Pub. Date: Oct. 16, 2014

(54) Earplug Wire Retention Tabs for Mobile Communication Device Casing

(71) Applicants: Karen R. Mazique, Chicago, IL (US); Michael L. Barnett, Chicago, IL (US)

(72) Inventors: Karen R. Mazique, Chicago, IL (US); Michael L. Barnett, Chicago, IL (US)

(21) Appl. No.: 13/861,611

(22) Filed: Apr. 12, 2013

(51) Int. Cl. H02G 11/00

(52) U.S. Cl. CPC H02G 11/00
USPC 174/135

(57) ABSTRACT

The present invention discloses a cord retention device comprising a pair of pivoted tabs. The pivoted tabs can be frictionally locked in different positions when rotated axially in hollow dwell portions of their mounting brackets. The retention tabs are adapted to apply a compressive force to the wires or cords attached to a mobile electronic sound device and prevent the wires or cords from tangling. In one embodiment of the present invention, the pivoted tabs are substantially 180 degree pivoted to facilitate easy release of the retained wires or cords.

### FIELD OF THE INVENTION

The present disclosure relates to an apparatus for holding the earplug wire of a personally carried electronic device. More specifically, it relates to a pair of foldable earplug wire retention tabs to prevent tangling.

### BACKGROUND OF THE INVENTION

Handheld personal electronic devices such as cellular telephones, MP3 players, pocket computers and the like are capable of emitting sounds. The devices are usually connected to cords for a microphone and ear pieces that enable the sound to be heard privately. These earplugs and cords are hard to manage and easily tangled and broken. Accordingly, there exists a need for an apparatus for easily holding and releasing the earplug wire of a personal carried electronic device.

It has been previously suggested that cords on portable electrical devices can be held by retainer housing assemblies such as disclosed in U.S. Pat. No. 7,108,544. That patent discloses a cord retainer having a flange and a base cooperating with a surface of the housing of the electrical device or the case of the device, to at least partially define a groove into which a cord may be manually wound. The cord housing mounted on the mobile device will make the device significant larger and bulky. The user will also need to manually unwind the cords before using the earplugs.

Another U.S. Pat. No. 6,698,560 discloses a cord retention device having a base member that has a pair of prongs. The cord may be wrapped around the prongs when not in use. The prongs may be extended and folded in place thus allowing the cord to be wrapped and may be retracted to be flush with a surface of the mobile phone device. In one of the embodiments disclosed in that patent, the swiveling prongs are attached in the slots on the side wall of the mobile device via hinges. However, the patent does not disclose a locking mechanism that can lock the prongs in their standing positions when the cord is being wrapped around the prongs. When the cables are wrapped around the prongs, the prongs have a tendency to recess towards the slots and loosen the cables.

### SUMMARY OF THE INVENTION

The presently disclosed invention is a device that can retain the cord attached to a mobile device and can conveniently release the cord. The cord retention device comprises a pair of 180 degree pivoted tabs. When each tab is pivoted outward, a user may wind the earpiece cables around the tabs. The user may unwind the earpiece cables by flipping the tabs towards each other. The user may also unwind only a portion of the cables when the earpieces are being used manually thus preventing excess cables from hanging loose.

The pair of tabs can be mounted on a pivotal, over-center snap lock tubular mounting bracket. The tabs are adapted to rotate axially in hollow portions of the mounting bracket. As each tab is rotated, a portion of each tab contacts the edges of a nose portion of the mounting brackets to form a locking mechanism to force the legs of the tabs inward.

### BRIEF DESCRIPTION OF THE DRAWINGS

The features of the present invention which are believed to be novel are set forth with particularity in the appended claims. The invention may best be understood from the following detailed description of the currently illustrated embodiments thereof taken in conjunction with the accompanying drawings wherein like numerals refer to like parts, and in which:

FIG. 1 is a perspective view of an example of a pair of earplug wire retention tabs on the back of a mobile electronic device, with ear bud cords being wrapped around the retention tabs.

FIG. 2 is a perspective view of the mobile electronic device of FIG. 1, showing the retention tabs in a downward locked position holding the wound cords against the rear surface of the mobile device, or a casing for the mobile device.

FIG. 3 is a perspective view of an example of a pair of earplug wire or cord retention tabs attached to a strip, and the strip attached to a side surface of a mobile electronic device, or to the side of a casing for the electronic device, showing the cords being wound around the retention tabs.

FIG. 4 is a perspective view of the embodiment of FIG. 3, showing the retention tabs in a downward locked position holding the wound cords against the side surface of the strip.

FIG. 5 is a detailed perspective view of the strip and cord retention tabs of the embodiment of the invention shown in FIGS. 3 and 4.

FIG. 6 is a detailed elevation view of an embodiment of a tubular mounting bracket and cord retention tab of the present invention, where each cord retention tab has two frictional lock positions.

FIG. 7 is a perspective detail view of another embodiment of a tubular mounting bracket and cord retention tab, where each cord retention tab has three frictional lock positions.

FIGS. 8A, B and C are schematic illustrations of the three frictional lock positions of each of the cord retention tabs of the embodiment of FIG. 7.

### DETAILED DESCRIPTION OF THE INVENTION

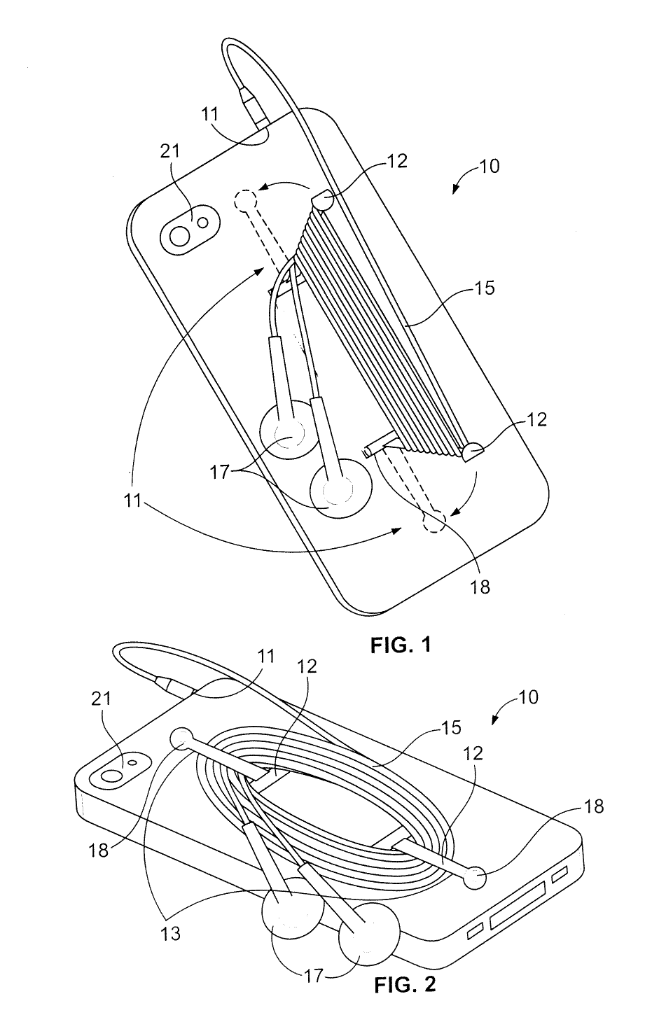

FIG. 1 is perspective view of the rear of a casing 10 for a mobile phone 21 or other communication device where the user attaches a wire or cord 15 connected to earpieces 17 to the sound output port 11 of device 21. A pair of pivoted wire or cord retention tabs 12 are pivotally mounted directly to the rear surface of casing 10 of the electronic device. If the electronic device is being used without a casing 10, the tabs 12 can be pivotally mounted to the rear of the electronic device itself. The tabs 12 are spaced apart from each other and are pivotable in tubular mounting brackets 18. The tabs 12 are 90 degrees rotatable in one embodiment of the present invention, and are 180 degrees pivotal in another embodiment. When the tabs 12 are pivoted outward in an up frictional lock position 11, a user may wind the earpiece wires 15 around the two tabs 12. Winding the wires or cords 15 around tabs 12 prevents the cables from hanging loose when the earpieces 17 are not in use.

After winding the wires 15 around the tabs 12, the user manually pushes the tabs 12 down to a down frictional lock position 13, as illustrated in FIG. 2. As will be explained, in the position shown in FIG. 2, the frictional locking mechanism of mounting brackets 18 will apply a force to the wound wires tending to maintain the wires in the wound position against the rear surface of casing 10. The user may easily release the wires 15 for the earpieces 17 by rotating both of the tabs 12 inwardly toward each other, or rotating one tab 12 in the direction towards the other tab 12. When either of the tabs 12 is rotated the inward position, the tabs 12 can no longer retain wires 15, and the wires 15 are released for the user to utilize conveniently. Also, if the electrical device 21 is in a shirt or blouse pocket, the user may manually unwind only a portion of the wires 15 when the earpieces 17 are being used, thus preventing excess wires from hanging loose.

Alternatively to mounting the tabs 12 to casing 10 of an electrical device 21, the tabs 12 can also be pivotally attached directly to the rear surface of the electrical device 21. When the wires 15 are being used instead of retained by the tabs 12, the tabs 12 are folded to at least partially contact the surface they are mounted on. The folded position of the tabs 12 takes very little space and has practically no effect on portability of the electrical device 21.

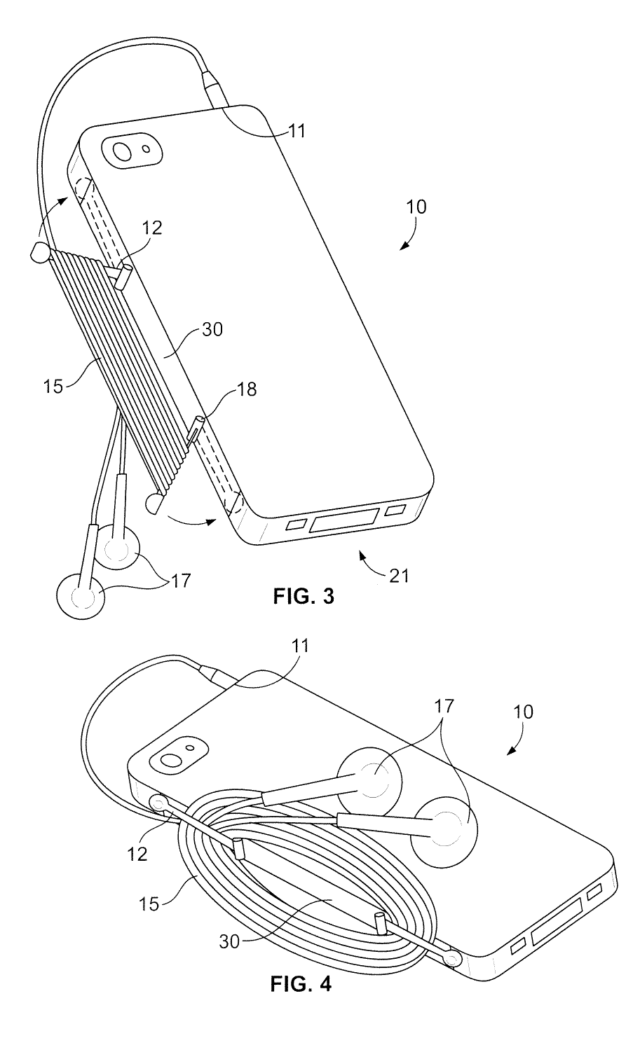

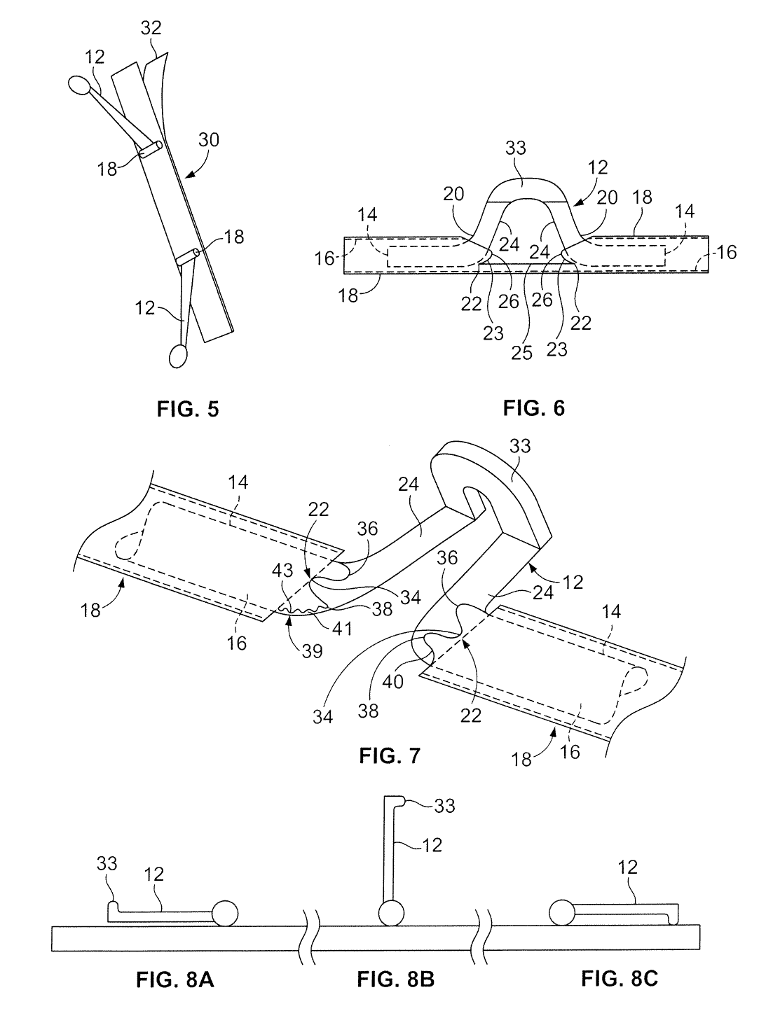

Referring to FIGS. 3 and 4, there is shown a pair of earplug wire retention tabs 12 attached to a strip 30, and the strip 30 is attached to the side surface the casing 10 of a mobile electronic device 21. A pair of pivoted tabs 12 are attached to strip 30. The pivoted tabs 12 are held by a pair of tubular mounting brackets 18 on the strip 30. The tabs 12 are spaced a predetermined distance from each other because they are fixed on the strip 30. In the illustrated embodiment, the strip 30 can be of plastic, metal or other suitable material. The strip 30 has an adhesive coating 32 (FIG. 5) on the side opposite mounting brackets 18 to attach the strip 30 directly to a side edge of casing 10, as shown in FIGS. 3 and 4. Alternatively the strip 30 may also be attached to the rear surface of casing 10 (not shown). FIG. 3 shows the wires or cords 15 being wound around tabs 12. FIG. 4 illustrates the wires 15 held in a frictional locked position against the strip 30 when the tabs are rotated downward and outward. FIG. 5 shows each of the retention tabs 12 mounted in a spaced apart position on strip 30, and showing adhesive coating 32 on the underside of strip 30.

FIG. 6 illustrates the details of an embodiment of the locking mechanism used in the mounting brackets 18 to frictionally lock the pivoted tabs 12 in their respective positions. Each tab 12 has horizontal outwardly extending portions 14 inserted into the hollow portions 16 of mounting brackets 18. The extending portions 14 of the tabs 12 are adapted to rotate axially in hollow portions 16 of a corresponding bracket. Each hollow mounting bracket 18 has an opening at its center. Nose portions 22 are located on each side of the hollow portion 16 of the mounting brackets. In the embodiment illustrated in FIG. 6, the top of tab 12 has a portion 33 projecting outwardly from the plane of tabs 12. The portion 33 prevents the wires 15 from slipping off from the outer ends of tabs 12 during the winding process.

In the embodiment illustrated in FIG. 6, the tabs 12 can be rotated between two frictional locked positions in the opening on the brackets 18. Opening 25 in this embodiment allows the tabs 12 to rotate from a position adjacent to the casing 10 (not shown) and stopping at a position 90 degrees perpendicular to the casing 10 (not shown) when the tabs 12 reach the closing edge of the opening 25. As each tab 12 is rotated, a portion 20 of each tab contacts the edge surfaces of nose portions 22 on either side of mounting brackets 18, such that the legs 24 of tabs 12 are forced inward towards each other as the tabs 12 rotates. When the portions 20 on each tab 12 advance past the apex 26 of the nose portion 22, legs 24 move outward again into dwell portions 23 due to the inherent spring action of tabs 12. Each tab 12 residing in dwell 23 will be frictionally locked in the winding position (FIGS. 1, 3) between the apex 26 of the nose and the closing edge of the opening 25. The user winds the wires or cords 15 around the tabs 12 when the tabs are in the winding position 90 degrees perpendicular to the casing 10.

When the user finishes winding the wires or cords 15, the tabs 12 are rotated down to the position shown in FIGS. 2 and 4. The tabs 12 are held in a winding or retaining position by the snap friction lock mechanism of nose portions 22 of brackets 18. The snap friction lock mechanism applies a compressive force to the wound cables to assist in maintaining the cables in place around the tabs 12 in the outward retaining position.

While the opening 25 shown in FIG. 6 allows the retention tabs 12 to rotate a maximum of 90 degrees in relation with the casing 10 (not shown), the mounting bracket 18 can also be designed to allow different angles for the purpose of frictionally locking the tabs 12 in an appropriate position to receive the wires or cords 15.

In the embodiment illustrated in FIG. 7, the edge of each nose portion 22 of each mounting bracket 18 has double apexes 36 and 38, and an intermediate dwell portion 34. As each tab 12 is rotated, the tab 12 can be frictionally locked at its cord lock position, cord winding extended lock position, and cord release positions as illustrated in FIGS. 8A-C.

FIG. 8A shows a retention tab 12 in its cord release lock position. In this position, referring to FIG. 7, the tab 12 is located in dwell 37 at the outer edge of the first apex 36. When both tabs 12 in the device are in this cord release lock position, the tabs 12 are not retaining any wires. When the user rotates tab 12 axially in hollow portion 16 of mounting bracket 18, the legs 24 of the tab 12 are forced inward until they reach the first apex 36. The tab 12 is locked in the extended cord-winding lock position (FIG. 8B) when the legs 24 continue to rotate past the first apex 36, and come to rest in dwell portion 34 (FIG. 7) located between the double apexes 36 and 38. The extended lock position shown in FIG. 8B, allows the user to wind the wires 15 with one hand around the two tabs 12 while holding electronic device 21 in the other hand. The top curved portion 33 of the tabs facilitates the retention of the wires 15. The tabs 12 remain in the extended lock position (FIG. 8b) in dwell portion 34 during the winding process because the double apexes 36 and 38 apply a force to prevent the legs 24 from rotating outward or inward.

The tab 12 can be further rotated so the legs 24 of the tab 12 are able to reach and pass the second apex 38 and rest in dwell portion 39 (FIG. 7), and thus become frictionally locked in the cord lock position as shown in FIG. 8C. The cord lock position of FIG. 8C maintains the cables in place around the tabs 12. The apex 38 applies an over-center snap lock compressive force to the legs 24, while force holds the retention tabs 12 in a direction towards the surface of casing 10. This force holds the cords 15 in their wound position, as illustrated in FIGS. 2 and 4.

The second apex 38 has an outer edge that contacts the leg 24 of the retention tab 12. In one embodiment of the outer edge 40 illustrated in FIG. 7, the outer edge 40 is smooth. In an alternative embodiment, the outer edge 41 of the second apex 38 leading to dwell portion 39 has sawtooth or serrated configuration 43 along the edge 41. Depending on the volume of cords 15 wound around the tabs 12, the tabs 12 are raised to different angular heights. The sawtooth or serrated shaped outer edge 41 helps in maintaining the legs 24 of the retention tabs 12 at the appropriate height to accommodate different amount of wires 15 the user retains by the tabs 12. Two substantially similar sawtooth outer edges 39 can be placed on both sides of the second apex 38. Both outer edges 40 of the second apex 38 can also be smooth as is outer edge 40 illustrated in FIG. 7.

The apex 26 (FIG. 6) and double apexes 36 and 38 (FIG. 7) of the nose portion of each mounting bracket 18 can vary in size and position in manufacturing to better accommodate the wires or cords 15 wound around the tabs 12. The present invention has advantages over prior art cord winding devices because of its simplicity in manufacturing, and is easy to install and use on a mobile electrical device. The tabs 12 in the present invention can move pivotally approximately 180 degrees to retain and release the earpiece wires 15. The frictional locking mechanism on the mounting brackets 18 overcomes the disadvantage of the tabs becoming loose as in prior devices.

While one particular embodiment of earplug wire retention tabs for mobile communication devices of the present invention has been shown and described, it will be apparent to those skilled in the art that changes and modifications may be made without departing from the true spirit and scope of the present invention. It is the intent of the appended claims to cover all such changes and modifications as fall within the true spirit and scope of the invention.

What is claimed:

1. An apparatus for managing wires attached to a mobile electronic sound device, comprising:
at least two spaced apart pivotable tabs rotatably attached by a frictional locking mounting bracket to the exterior surface of one of said mobile electronic sound device and a casing holding said mobile electronic device;
said frictional locking mounting device frictionally locking each of said at least two tabs in a first frictionally locked position;
said at least two tabs adapted to receive and support a wound strand of wires when in said first frictionally locked position.

2. The apparatus of claim 1, wherein:
said at least two tabs are pivotally movable to a second frictionally locked position;
said at least two tabs adapted to apply a compression force to said wound strand of wires when said at least two tabs are in said second position.

3. The apparatus of claim 2 wherein:
said mounting bracket comprises a pair of hollow tubes;
a portion of each of said tabs extending into said hollow tubes.

4. The apparatus of claim 1 wherein:
said mounting brackets are mounted on one surface of an attaching strip, and a second surface of said attaching strip is adhesively attached ton one of said mobile electronic sound device and casing for said mobile electronic sound device to mount the brackets and at least two pivotal tabs to said electronic device or said casing.

5. The apparatus of claim 4, wherein:
said attaching strip is made from materials selected from plastic and metal.

6. An apparatus for managing wires attached to a mobile electronic sound device, comprising:
at least two spaced apart pivoted tabs, said tabs axially rotatable in a pair of hollow mounting brackets;
each of said tabs having leg portions inserted into said hollow mounting brackets; and
each of said mounting brackets having a frictional locking mechanism applying a force to hold each said tab in one of several predetermined positions.

7. The apparatus of claim 6, wherein:
said frictional locking mechanism comprises at least one pair of nose portions, each said nose portion having at least one apex and a dwell portion on both sides of said apex, said tabs moving into one of said dwell portions when the tabs are rotated, said dwell portion applying a frictional locking force to the corresponding tab.

8. The apparatus of claim 6 wherein:
said hollow mounting brackets are attached to a mounting strip, said mounting strip adapted to be adhesively attached to one of an exterior surface of said mobile electronic sound device and a casing for said mobile electronic sound device.

9. The apparatus of claim 7, wherein:
said locking mechanism comprises at least one nose portion having said first apex and a second apex, an additional dwell portion located between said first and second apex.

10. The apparatus of claim 9, wherein:
said second apex has a sawtooth shaped outer edge.
